(19) United States
(12) Patent Application Publication
(10) Pub. No.: US 2008/0135388 A1
(43) Pub. Date: Jun. 12, 2008

(54) OLED rocker switch

(75) Inventors: George Hoehne, St. Charles, IL (US); Joe Ferrantelli, Orland Park, IL (US); Robert Huizenger, Woodridge, IL (US)

Correspondence Address: SCHIFF HARDIN, LLP;PATENT DEPARTMENT, 6600 SEARS TOWER, CHICAGO, IL, 60606-6473, US

(73) Assignee: GAMESMAN LIMITED

(21) Appl. No.: 11/595,094

(22) Filed: Nov. 10, 2006

(51) Int. Cl. H01H 23/30; H01J 1/62

(52) U.S. Cl. 200/312; 200/339; 313/504

(57) ABSTRACT

A rocker switch has a housing, a switch supported by the housing, a rocker supported by the housing, a switch actuator operably associated with the switch and the rocker so as to operate the switch upon rocking of the rocker, and a display supported by the housing in a position to be viewable by a user of the rocker switch.

### TECHNICAL FIELD

The present application relates to a rocker switch and, more particularly, to a rocker switch having a lighted display device.

### BACKGROUND OF THE INVENTION

Switches incorporating lighted displays have been used in a variety of applications such as on amusement, gaming, and vending machines. Such switches are typically comprised of a switch operator, an opaque legend plate, and a back light to illuminate the legend plate. This type of switch only accommodates a single color background with a single unchanging message or graphic.

A more recent configuration of an illuminated switch used primarily in instrumentation includes a push button, a liquid crystal display (LCD) panel, and a back light to illuminate the liquid crystal display panel. Alternatively, it is known to mount the light that illuminates the liquid crystal display panel to the side of the panel. Such a push button switch has been used to convey information, such as the function of the push button switch, to the user.

The use of a liquid crystal display panel in a push button switch has a number of problems. For example, a liquid crystal display panel has a very narrow viewing angle. A narrow viewing angle is desirable for some applications such as computers where a user often does not wish the contents of the computer's screen to be seen by anyone other than the user. However, in many applications, such as where the display is being used to advertise information, a narrow viewing angle is a detriment.

Also, a liquid crystal display panel has a relatively slow response time, typically referred to as latency. This problem is exacerbated at low temperatures and, therefore, supplemental heating may be required for low temperature applications.

Moreover, a liquid crystal display panel requires backlighting, which adds to the cost of a push button switch and which also adds to the power consumption of a push button switch using a liquid crystal display panel.

Moreover, many switches with an illuminated display have limited capabilities. For example, known switches typically operate only a single switch so that the functionality offered by these switches is limited. Also, known switches typically have a single display, which again limits the amount of information that can be provided to a user.

The present invention is directed to a switch which overcomes one or more of these or other problems.

### SUMMARY OF THE INVENTION

According to one aspect of the present invention, a rocker switch comprises a housing, a switch, a rocker, a switch actuator, and a variable display. The switch is supported by the housing. The rocker is supported by the housing, the rocker has a return position and at least one switch operating position, the rocker is configured to rock to the switch operating position when a user applies pressure to the rocker, and the rocker is configured to automatically return to the return position when the user removes pressure from the rocker. The switch actuator is operably associated with the switch and the rocker so as to operate the switch when the rocker is rocked. The variable display is supported by the housing in a position to be viewable by a user of the rocker switch.

According to another aspect of the present invention, a rocker switch comprises a housing, a switch, a rocker, a switch actuator, and an organic light emitting diode display. The switch is supported by the housing. The rocker is supported for rocking movement by the housing, and the rocker is operable by a user between at least two positions. The switch actuator is operably associated with the switch and the rocker so as to operate the switch when the rocker is rocked between the at least two positions. The organic light emitting diode display is supported by the housing in a position to be viewable by the user.

According to still another aspect of the present invention, a rocker switch comprises a housing, a switch, a rocker, a switch actuator, and first and second display portions. The switch is supported by the housing. The rocker is supported by the housing, and the rocker is arranged to be rocked between at least first and second rocker positions. The switch actuator is operably associated with the switch and the rocker so as to operate the switch to provide a first switch output when the rocker is in the first rocker position and a second switch output when the rocker is in the second rocker position. The first display portion is controlled by the first switch output, and the second display portion is controlled by the second switch output.

### BRIEF DESCRIPTION OF THE DRAWING

These and other features and advantages will become more apparent from the detailed description when taken in conjunction with the drawing in which:

FIG. 1 is an isometric view of a rocker switch according to one embodiment of the present invention;

FIG. 2 is a top view of the rocker switch of FIG. 1;

FIG. 3 is a section view taken along section line 3-3 of FIG. 2;

FIG. 4 is a section view taken along section line 4-4 of FIG. 2;

FIG. 5 is a section view taken along section line 5-5 of FIG. 2;

FIG. 6 is a side view of the rocker switch of FIG. 1;

FIG. 7 is a front view of the rocker switch of FIG. 1;

FIG. 8 is an exploded view of the rocker switch of FIG. 1;

FIG. 9 illustrates an example of a controller that can be used in connection with the rocker switch of FIGS. 1-8; and,

FIG. 10 illustrates one example of the information that can be displayed by the display of the rocker switch.

### DETAILED DESCRIPTION

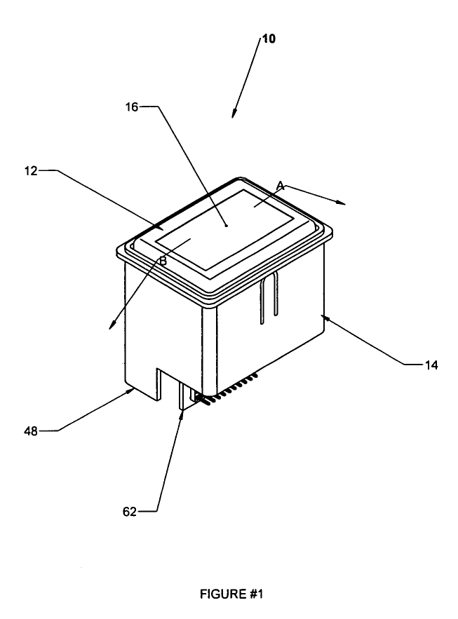

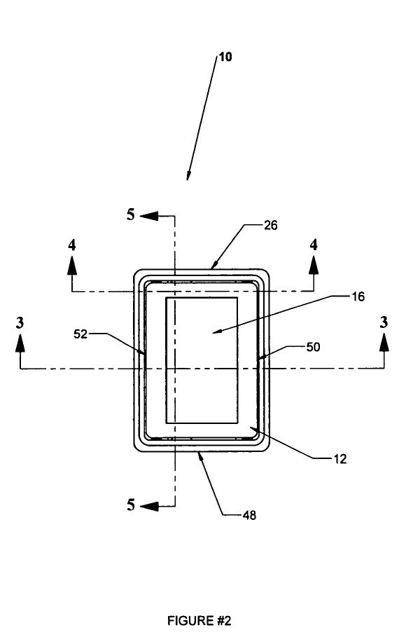

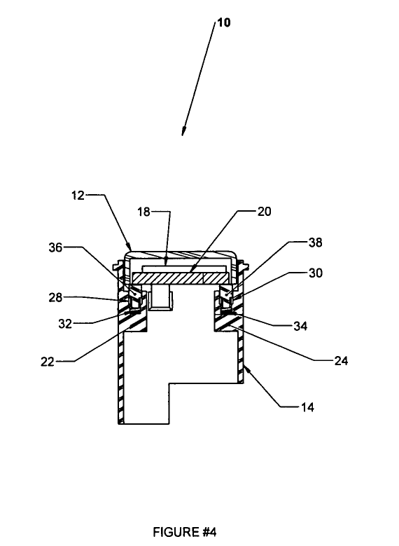

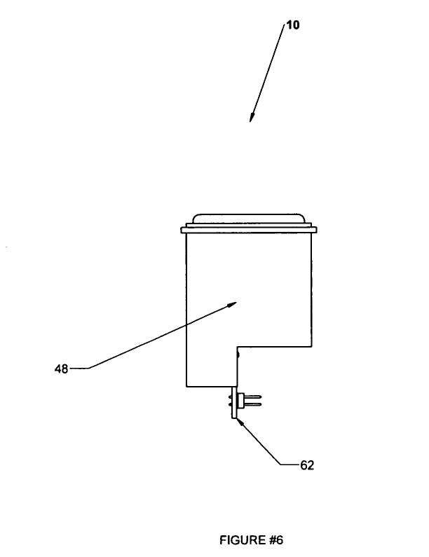

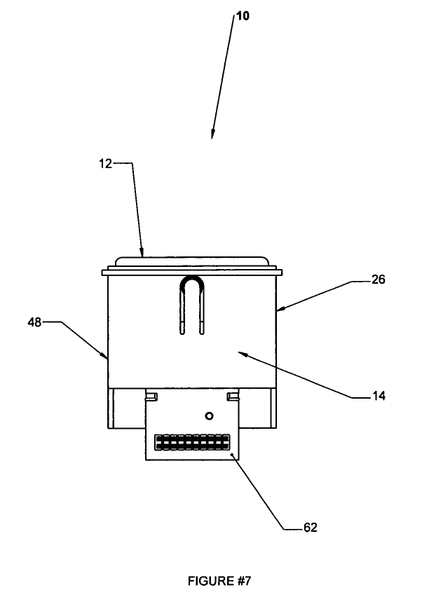

FIGS. 1-8 show a rocker switch 10 having a rocker 12 that is suitably captured by a housing 14. The rocker 12 may be a transparent rocker. Alternatively, the rocker 12 may be arranged to support a transparent window 16 so that a display 18, such as a variable display (a display whose displayed information can be changed), is visible to the user through the rocker 12. The display 18 is supported by a support shelf 20 that is suitably affixed to the housing 14. As shown in FIG. 4, the rocker switch 10 is provided with a clearance between the display 18 and the support shelf 20 on the one hand and the housing 14 on the other to accommodate rocking of the rocker 12.

The transparent window 16, for example, may be a transparent lens arranged to magnify or otherwise enhance the information provided by the display 18. The display 18, for example, may be an organic light emitting diode (OLED) display. Organic light emitting diode (OLED) displays are known and may be obtained from various manufacturers. Generally, an organic light emitting diode is a composite of a thin film of light emitting polymer applied to a glass or plastic substrate. In the presence of an electric field, the polymer emits light. However, the display may be other types of displays such as an LED, an LCD, etc.

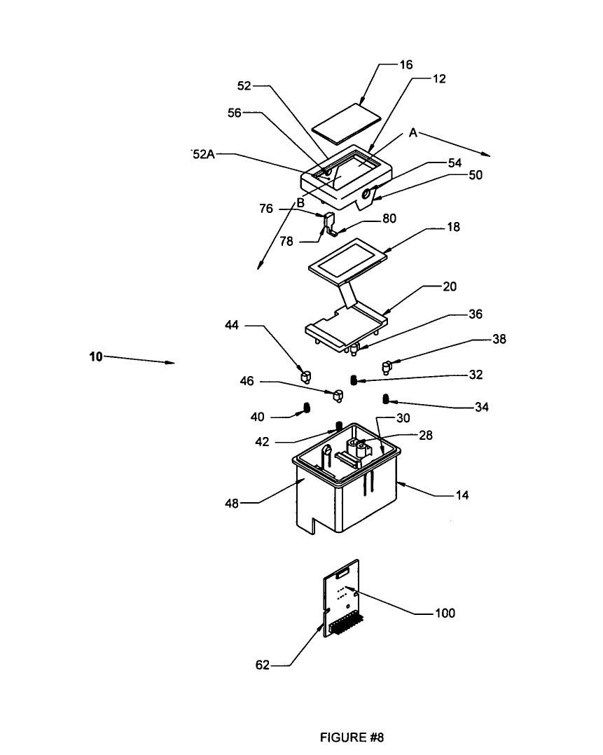

As further shown in FIG. 4, the housing 14 is provided with plunger receptacles 22 and 24 near a side 26 of the housing 14. The plunger receptacles 22 and 24 have corresponding wells 28 and 30. A return spring 32 is provided in the well 28, and a return spring 34 is provided in the well 30. A plunger 36 is provided in the well 28 and is biased by the return spring 32 away from the bottom of the well 28. Similarly, a plunger 38 is provided in the well 30 and is biased by the return spring 34 away from the bottom of the well 30. A similar set of plunger receptacles (not shown), wells (not shown), return springs 40 and 42 (see FIG. 8), and plungers 44 and 46 (see FIG. 8) may be provided near a side 48 of the housing 14.

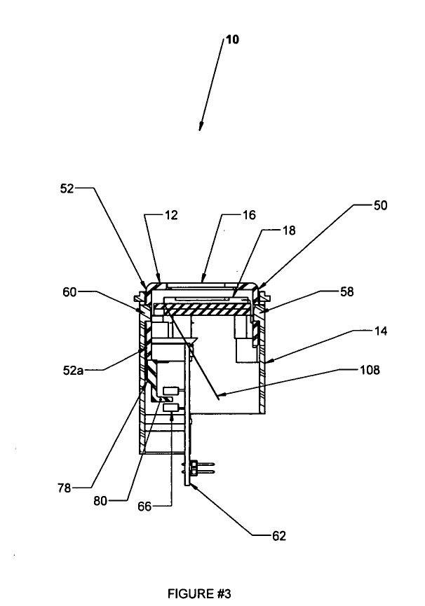

As shown in FIGS. 3 and 8, the rocker 12 has sides 50 and 52. The side 50 has a recess or opening 54, and the side 52 has a recess or opening 56. The recess or opening 54 accommodates a post 58 of the housing 14, and the recess or opening 56 accommodates a post 60 of the housing 14.

Accordingly, the posts 58 and 60 capture the rocker 12 to the housing 14. The posts 58 and 60 also act as fulcrums or pivot points about which the rocker 12 may be rocked by a user in the direction of arrow A and B shown in FIGS. 1 and 8.

When the user presses the rocker 12 so that rocker 12 rocks in the direction indicated by the arrow A, the rocker 12 pushes the plungers 36 and 38 to compress the return springs 32 and 34. When the user releases the pressure on the rocker 12, the return springs 32 and 34 decompress and push the plungers 36 and 38 to return the rocker 12 to the center (or return) position where none of the return springs 32, 34, 40, and 42 are compressed.

Similarly, when the user presses the rocker 12 so that rocker 12 rocks in the direction indicated by the arrow B, the rocker 12 pushes the plungers 44 and 46 to compress the return springs 40 and 42. When the user releases the pressure on the rocker 12, the return springs 40 and 42 decompress and push the plungers 44 and 46 to return the rocker 12 to the center position where none of the return springs 32, 34, 40, and 42 are compressed.

Accordingly, with no pressure on the rocker 12, the return springs 32, 34, 40, and 42 maintain the rocker 12 in the center position.

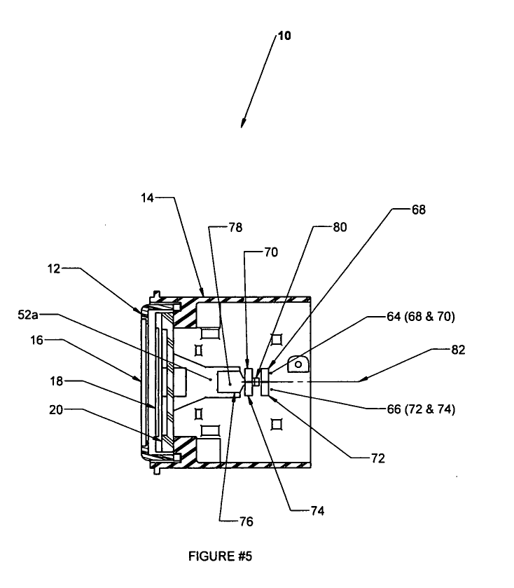

The housing 14 supports a circuit board 62. As shown in FIGS. 3 and 5, a pair of optical switches 64 and 66 are supported by the circuit board 62. The optical switch 64 includes switch members 68 and 70, and the optical switch 66 includes switch members 72 and 74. For example, the switch member 68 may be a light source, and the switch member 70 may be a light detector, or vice versa. Similarly, the switch member 72 may be a light source, and the switch member 74 may be a light detector, or vice versa.

As shown in FIGS. 3, 5, and 8, the side 52 of the rocker 12 has an extension 52a that causes to the side 52 to extend farther into the housing 14 than does the side 50. A flag 76 has first and second flag portions 78 and 80. The first flag portion 78 is suitably affixed to the extension 52A of the side 52 of the rocker 12. The second flag portion 80 is at a right angle to the first flag portion 78 and is configured to operate the optical switches 64 and 66. Together, the extension 52A of the side 52 and the flag 76 form a switch actuator that is moved by the rocker 12 to operate the switch formed by the optical switches 64 and 66.

When no pressure is applied to the rocker 12 by a user, the return springs 32, 34, 40, and 42 bias the rocker 12 to the center position, and the second flag portion 80 is aligned with a neutral axis 82. In this position, neither of the optical switches 64 and 66 is operated. However, when pressure is applied by the user so as to rock the rocker 12 in the direction of arrow A, the side 52 moves the flag 76 so that the second flag portion 80 operates the optical switch 66 and the return springs 32 and 34 compress. Accordingly, the second flag portion 80, for example, interrupts light between the switch members 72 and 74. When this pressure is released by the user, the return springs 32 and 34 cause the rocker 12 to return to its center position and the side 52 moves the flag 76 so that the second flag portion 80 is moved away from the optical switch 66 and is again aligned with the neutral axis 82. Accordingly, the second flag portion 80, for example, again allows light between the switch members 72 and 74.

On the other hand, when pressure is applied by the user so as to rock the rocker 12 in the direction of arrow B, the side 52 moves the flag 76 so that the second flag portion 80 operates the optical switch 64, and the return springs 40 and 42 compress. Accordingly, the second flag portion 80, for example, interrupts light between the switch members 68 and 70. When this pressure is released by the user, the return springs 40 and 42 cause the rocker 12 to return to its center position and the side 52 moves the flag 76 so that the second flag portion 80 is moved away from the optical switch 64 and is again aligned with the neutral axis 82. Accordingly, the second flag portion 80, for example, again allows light between the switch members 68 and 70.

The optical switch described above is of the interruptive type. Alternatively, the optical switch could be of the reflective type.

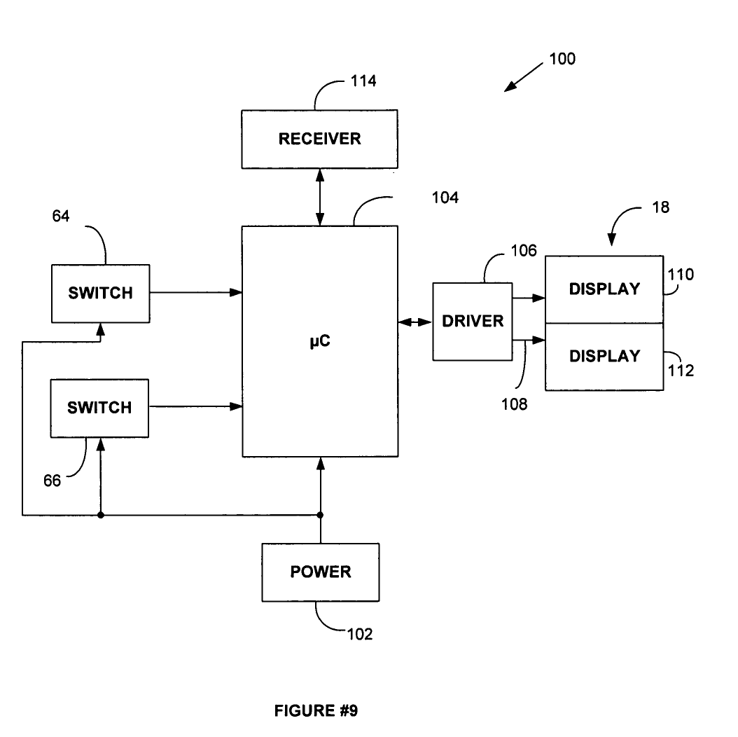

The circuit board 62 may also be arranged to support a controller circuit 100, which is shown in more detail in FIG. 9. The controller circuit 100 includes a power supply 102, a microcontroller 104, and a display driver 106. The power supply 102 may perform power management and supervisory functions. The microcontroller 104 is responsible for input/output, display driver management, and display update functions, and includes memory (e.g., flash and RAM). The display driver 106 manages row and column selection, buffer refresh, and display control functions for the display 18. A display interconnect 108 (shown disconnected in FIG. 3) interconnects the display driver 106 and the display 18.

The display 18 may have first and second display portions 110 and 112 that are independently controlled by the microcontroller 104. As an example, the first and second display portions 110 and 112 may be independently controlled by the microcontroller 104 to provide different information to the user. Thus, the first display portion 110 may be controlled by the microcontroller 104 to provide first information to the user, and the second display portion 112 may be controlled by the microcontroller 104 to provide second information to the user, where the second information is different from the first information.

Moreover, it is possible for the microcontroller 104 to independently change the first and second information upon actuation of the rocker switch 10. For example, when the user operates the rocker switch 10 so as to operate the optical switch 64, the first information displayed by the first display portion 110 may be changed by the microcontroller 104 while the second information displayed by the second display portion 112 is not changed. Similarly, when the user operates the rocker switch 10 so as to operate the optical switch 66, the second information displayed by the second display portion 112 may be changed by the microcontroller 104 while the first information displayed by the first display portion 110 is not changed.

Alternatively, when the user operates the rocker switch 10 so as to operate the optical switch 64, the first information displayed by the first display portion 110 may be changed by the microcontroller 104 to display third information and the second information displayed by the second display portion 112 may be changed by the microcontroller 104 to display fourth information, where the third and fourth information are different from one another and from the first and second information. Other alternatives are also possible.

The controller circuit 100 permits the rocker switch 10 to be programmed to perform various functions. For example, the controller circuit 100 is programmed to cause the first and/or second display portions 110 and 112 of the display 18 to change from an instruction display to a feedback display and/or from a feedback display to an instruction display. Accordingly, the rocker switch 10 enriches the experience of the user in using the associated machine.

As another example, when the rocker 12 is rocked to a position where the optical switch 64 or the optical switch 66 is operated, the first and/or second display portions 110 and 112 of the display 18 may be controlled to change from a first display to a second display, and when the rocker 12 is released to return to its center position, where the optical switch 64 or the optical switch 66 is operated, the first and/or second display portions 110 and 112 of the display 18 may be controlled to change from the second display to the first display or to a third display.

As still another example, the controller circuit 100 may be programmed to cause each of the first and/or second display portions 110 and 112 of the display 18 to display multiple functions of the rocker switch 10 when used on a particular machine. Thus, the machine and its rocker switches can be readily re-programmed, making the machine more versatile.

As yet a further example, the controller circuit 100 can be programmed to cause the first and/or second display portions 110 and 112 of the display 18 to display the same or different advertisements, and these advertisements can be changed as the result of the passage of time, as a result of the operation of the rocker switch 10, or otherwise.

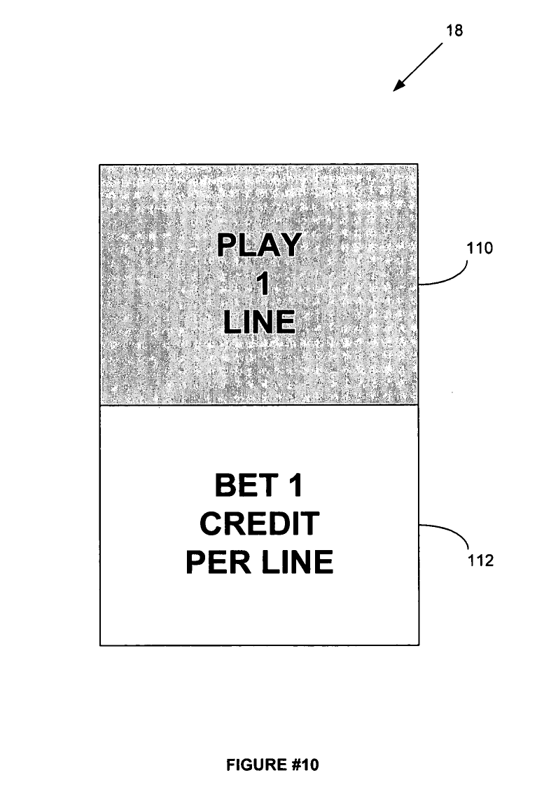

FIG. 10 illustrates one example of the information that can be displayed by the display 18 of the rocker switch 10. As can be seen in FIG. 10, the first and second display portions 110 and 112 can be controlled to different information.

Optionally, the controller circuit 100 can include an RF transceiver 114 in order to couple the controller circuit 100 with a remote station by way of an RF channel. In this way, the rocker switch 10 and/or the machine with which the rocker switch 10 is used may be programmed and re-programmed remotely.

An organic light emitting diode (OLED) display if used provides many advantages over the prior art. For example, an organic light emitting diode (OLED) display has a wide viewing angle so that its displays can be more easily seen by users approaching a machine. Also, an organic light emitting diode (OLED) display has a very fast response time which allows the displays to be quickly changed during use of the machine without detracting from the experience of the user. Moreover, an organic light emitting diode (OLED) display requires no backlighting so that the machine is less costly to make and use.

Certain modifications of the present invention have been discussed above. Other modifications will occur to those practicing in the art of the present invention. For example, as described above, the controller circuit 100 includes the RF transceiver 114 that couples the controller circuit 100 with a remote station by way of an RF channel. However, receiving devices other than the RF transceiver 114 may couple the controller circuit 100 to the remote station. For example, sound or light receivers can be used to couple the controller circuit 100 to the remote station. As a further alternative, the controller circuit 100 can be hard wired to the remote station.

Moreover, the controller circuit 100 is shown as being supported by the housing 14. Alternatively, the controller circuit 100 need not be supported by the housing 14. For example, the controller circuit 100 can be supported by the machine on which the rocker switch 10 is mounted.

Furthermore, the rocker switch 10 includes optical switches 64 and 66. Instead, other forms of switches, such as microswitches, other forms of contact switches, magnetic switches, cam switches, etc. may be used in placed of the optical switches 64 and 66. In addition, more than one switch may be included in the rocker switch 10 on one or the other or both sides of the neutral axis 82. Thus, switches may be operated in sequence as the flag moves away from the neutral axis.

In addition, as described above, the display 18 has first and second display portions 110 and 112. The first and second display portions 110 and 112 may be portions of the same contiguous display element such as an OLED. Alternatively, the first and second display portions 110 and 112 may be separate, non-contiguous display elements such as separate, non-contiguous OLEDs.

Moreover, the housing 14 is shown in the drawings as having a contiguous elongate outer wall defining an interior space and having first and second opposing ends. A housing axis extends through the space and between the first and second opposing ends. The rocker 12 and the display 18 are in planes that are substantially perpendicular to the housing axis and are supported by the contiguous elongate outer wall of the housing 14 at the first end. The switch actuator 52A/76 extends through the space and between the first and second opposing ends in parallel to the housing axis. The optical switch 64/66 is also supported by the contiguous elongate outer wall. The second end of the contiguous elongate outer wall may be attached to a panel of a machine with which the rocker switch 10 is to be used such that the panel is in a plane substantially perpendicular to the housing axis. However, alternative housing arrangements are possible. For example, the rocker switch 10 may have one housing for the rocker 12 and the display 18 and a separate housing for the optical switch 64/66 with the actuator extending therebetween.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A rocker switch comprising:
a housing;
a switch supported by the housing;
a rocker supported by the housing, wherein the rocker has a return position and at least one switch operating position, wherein the rocker is configured to rock to the switch operating position when a user applies pressure to the rocker, and wherein the rocker is configured to automatically return to the return position when the user removes pressure from the rocker;
a switch actuator operably associated with the switch and the rocker so as to operate the switch when the rocker is rocked; and,
a variable display supported by the housing in a position to be viewable by a user of the rocker switch.

2. The rocker switch of claim 1 wherein the housing comprises a contiguous elongate outer wall defining an interior space and having first and second opposing ends, wherein a housing axis extends through the space and between the first and second opposing ends, wherein the rocker and the variable display are supported by the contiguous elongate outer wall at the first end so as to intersect the housing axis, wherein the switch actuator extends through the space and between the first and second opposing ends, and wherein the switch is supported by the contiguous elongate outer wall.

3. The rocker switch of claim 2 wherein the second end of the contiguous elongate outer wall is configured to mate with a panel occupying a plane that is substantially perpendicular to the housing axis.

4. The rocker switch of claim 1 wherein the variable display is mounted to the housing so that the variable display remains stationary as the rocker moves.

5. The rocker switch of claim 1 wherein the switch comprises an optical switch having a light source and a light detector, wherein the switch actuator is arranged to block light from the light source to the light detector when the rocker is in the switch operating position and to not block light from the light source to the light detector when the rocker is not in the switch operating position.

6. The rocker switch of claim 1 wherein the at least one switch operating position comprises a first operating position, wherein the rocker has a second switch operating position, wherein the rocker is configured to rock to the first switch operating position when the user applies a first pressure to the rocker, wherein the rocker is configured to rock to the second switch operating position when the user applies a second pressure to the rocker, wherein the rocker automatically returns to the return position when the user removes the first and second pressures from the rocker, wherein the switch actuator operates the switch to provide a first output when the rocker is in the first switch operating position, and wherein the switch actuator operates the switch to provide a second output when the rocker is in the second switch operating position.

7. The rocker switch of claim 6 wherein the switch comprises first and second optical switches, wherein the first optical switch has a first light source and a first light detector, wherein the second optical switch has a second light source and a second light detector, wherein the switch actuator is arranged to block light from the first light source to the first light detector when the rocker is in the first switch operating position and to not block light from the light source to the light detector when the rocker is not in the first switch operating position, and wherein the switch actuator is arranged to block light from the second light source to the second light detector when the rocker is in the second switch operating position and to not block light from the light source to the light detector when the rocker is not in the second switch operating position.

8. The rocker switch of claim 1 further comprising a circuit coupling the switch to the variable display so that the switch causes information being displayed by the variable display to change upon actuation of the switch.

9. The rocker switch of claim 1 further comprising a circuit coupled to the variable display so as to cause information being displayed by the variable display to change upon passage of time.

10. The rocker switch of claim 1 further comprising a receiver that controls the variable display based on a signal from a remote station.

11. The rocker switch of claim 1 wherein the variable display comprises an OLED display.

12. The rocker switch of claim 1 wherein the rocker has at least first and second rocker positions, wherein the switch actuator is operably associated with the switch and the rocker so as to operate the switch to provide a first switch output when the rocker is the first rocker position and a second switch output when the rocker is the second rocker position, wherein the variable display comprises first and second display portions, wherein the first display portion is controlled by the first switch output, and wherein the second display portion is controlled by the second switch output

13. The rocker switch of claim 12 wherein the variable display comprises an OLED display.

14. A rocker switch comprising:
a housing;
a switch supported by the housing;
a rocker supported for rocking movement by the housing, wherein the rocker is operable by a user between at least two positions;
a switch actuator operably associated with the switch and the rocker so as to operate the switch when the rocker is rocked between the at least two positions; and,
an organic light emitting diode display supported by the housing in a position to be viewable by the user.

15. The rocker switch of claim 14 wherein the housing comprises a contiguous elongate outer wall defining an interior space and having first and second opposing ends, wherein a housing axis extends through the space and between the first and second opposing ends, wherein the rocker and the organic light emitting diode display are supported by the contiguous elongate outer wall at the first end so as to intersect the housing axis, wherein the switch actuator extends through the space and between the first and second opposing ends, and wherein the switch is supported by the contiguous elongate outer wall.

16. The rocker switch of claim 15 wherein the second end of the contiguous elongate outer wall is configured to mate with a panel occupying a plane that is substantially perpendicular to the housing axis.

17. The rocker switch of claim 14 wherein the organic light emitting diode display is mounted to the housing so that the organic light emitting diode display remains stationary as the rocker rocks.

18. The rocker switch of claim 14 wherein the switch comprises an optical switch having a light source and a light detector, wherein the switch actuator is arranged to block light from the light source to the light detector when the rocker is in the switch operating position and to not block light from the light source to the light detector when the rocker is not in the switch operating position.

19. The rocker switch of claim 14 wherein the at least one switch operating position comprises a first operating position, wherein the rocker has a second switch operating position, wherein the rocker is configured to rock to the first switch operating position when the user applies a first pressure to the rocker, wherein the rocker is configured to rock to the second switch operating position when the user applies a second pressure to the rocker, wherein the rocker automatically returns to the return position when the user removes the first and second pressures from the rocker, wherein the switch actuator operates the switch to provide a first output when the rocker is in the first switch operating position, and wherein the switch actuator operates the switch to provide a second output when the rocker is in the second switch operating position.

20. The rocker switch of claim 19 wherein the switch comprises first and second optical switches, wherein the first optical switch has a first light source and a first light detector, wherein the second optical switch has a second light source and a second light detector, wherein the switch actuator is arranged to block light from the first light source to the first light detector when the rocker is in the first switch operating position and to not block light from the light source to the light detector when the rocker is not in the first switch operating position, and wherein the switch actuator is arranged to block light from the second light source to the second light detector when the rocker is in the second switch operating position and to not block light from the light source to the light detector when the rocker is not in the second switch operating position.

21. The rocker switch of claim 14 further comprising a circuit coupling the switch to the organic light emitting diode display so that the switch causes information being displayed by the organic light emitting diode display to change upon actuation of the switch.

22. The rocker switch of claim 14 further comprising a circuit coupled to the organic light emitting diode display so as to cause information being displayed by the organic light emitting diode display to change upon passage of time.

23. The rocker switch of claim 14 further comprising a receiver that controls the organic light emitting diode display based on a signal from a remote station.

24. A rocker switch comprising:
a housing;
a switch supported by the housing;
a rocker supported by the housing, wherein the rocker is arranged to be rocked between at least first and second rocker positions;
a switch actuator operably associated with the switch and the rocker so as to operate the switch to provide a first switch output when the rocker is the first rocker position and a second switch output when the rocker is the second rocker position;
first and second display portions, wherein the first display portion is controlled by the first switch output, and wherein the second display portion is controlled by the second switch output.

25. The rocker switch of claim 24 wherein the housing comprises a contiguous elongate outer wall defining an interior space and having first and second opposing ends, wherein a housing axis extends through the space and between the first and second opposing ends, wherein the rocker and the first and second display portions are supported by the contiguous elongate outer wall at the first end so as to intersect the housing axis, wherein the switch actuator extends through the space and between the first and second opposing ends, and wherein the switch is supported by the contiguous elongate outer wall.

26. The rocker switch of claim 25 wherein the second end of the contiguous elongate outer wall is configured to mate with a panel occupying a plane that is substantially perpendicular to the housing axis.

27. The rocker switch of claim 24 wherein the first and second display portions are mounted to the housing so that the first and second display portions remain stationary as the rocker rocks.

28. The rocker switch of claim 24 wherein the switch comprises an optical switch having a light source and a light detector, wherein the switch actuator is arranged to block light from the light source to the light detector when the rocker is in the switch operating position and to not block light from the light source to the light detector when the rocker is not in the switch operating position.

29. The rocker switch of claim 24 wherein the at least one switch operating position comprises a first operating position, wherein the rocker has a second switch operating position, wherein the rocker is configured to rock to the first switch operating position when the user applies a first pressure to the rocker, wherein the rocker is configured to rock to the second switch operating position when the user applies a second pressure to the rocker, wherein the rocker automatically returns to the return position when the user removes the first and second pressures from the rocker, wherein the switch actuator operates the switch to provide a first output when the rocker is in the first switch operating position, and wherein the switch actuator operates the switch to provide a second output when the rocker is in the second switch operating position.

30. The rocker switch of claim 29 wherein the switch comprises first and second optical switches, wherein the first optical switch has a first light source and a first light detector, wherein the second optical switch has a second light source and a second light detector, wherein the switch actuator is arranged to block light from the first light source to the first light detector when the rocker is in the first switch operating position and to not block light from the light source to the light detector when the rocker is not in the first switch operating position, and wherein the switch actuator is arranged to block light from the second light source to the second light detector when the rocker is in the second switch operating position and to not block light from the light source to the light detector when the rocker is not in the second switch operating position.

31. The rocker switch of claim 24 wherein the first and second display portions are controlled by the first and second switch outputs, respectively, so as to independently change information being displayed by the first and second display portions.

32. The rocker switch of claim 24 further comprising a circuit coupled to the first and second display portions so as to independently change information being displayed by the first and second display portions upon passage of time.

33. The rocker switch of claim 24 further comprising a receiver that controls the first and second display portions based on a signal from a remote station.
